(19) United States
(12) Patent Application Publication
(10) Pub. No.: US 2012/0269061 A1
(43) Pub. Date: Oct. 25, 2012

(54) Method and Apparatus for Selecting a Quality of Service Parameter

(75) Inventor: Sami Johannes Kekki, Helsinki (FI)

(73) Assignee: NOKIA CORPORATION, Espoo (FI)

(21) Appl. No.: 13/380,518

(22) PCT Filed: Apr. 19, 2010
(86) PCT No.: PCT/FI2010/050315

§ 371 Date: Mar. 12, 2012

(30) Foreign Application Priority Data
Jul. 6, 2009 (GB) 0911730.0

(51) Int. Cl. H04W 28/24

(52) U.S. Cl. 370/230

(57) ABSTRACT

A method comprising using information about predicted load in a geographic location as a function of time to select a quality of service parameter at a particular time in said geographic location.

### FIELD OF THE INVENTION

The present invention relates to a method and apparatus.

### BACKGROUND

A communication system can be seen as a facility that enables communication sessions between two or more entities. For example, mobile communication systems provide for communications on wireless interfaces between user equipment and/or other nodes. The communications may comprise, for example, communication of voice, electronic mail (email), text messages, multimedia, other data and so on. Users may thus be offered and provided numerous services via their user equipment. Non-limiting examples of the services include two-way or multi-way calls, data communication or multimedia services or simply an access to a data communications network system such as the Internet.

User equipment which has accessed a system may also be provided broadcast or multicast content. Non-limiting examples of such content include downloads, television and radio programmes, videos, advertisements, various alerts and other information.

A communication system can be provided, for example, by a communication network and one or more compatible user equipment. The communication network may be a large network providing nationwide cover, continent-wide cover, or even global cover. However, the communication network may also be provided by a local network. In a wireless communication system, at least part of the communications, between two nodes, occurs over a wireless link. Examples of wireless systems include public land mobile networks (PLMN), satellite based communication systems and wireless local networks, for example wireless local area network (WLAN).

The user equipment can access the communication system via an access node such as a base station or the like. A feature of wireless systems is that they provide mobility for the users. User equipment can be moved from a cell or the like to another cell in a network. User equipment is also typically allowed to enter into another network.

The communication system and associated user equipment typically operate in accordance with a given standard or standards and/or specifications which set out what the various entities associated with the system are permitted to do and how that should be achieved. For example, the standard or specification may define if a communication device is provided with a circuit switched carrier service or packet switched carrier service or both.

Communication protocols and/or parameters which should be used for the connection are also typically defined.

A guaranteed bit rate (GBR) is used for services which have a particular quality of service requirement necessitating the reservation of dedicated bit rate resources.

### SUMMARY OF EMBODIMENTS OF THE INVENTION

According to a first aspect of the present invention, there is provided a method comprising using information about predicted load in a geographic location as a function of time to select a quality of service parameter at a particular time in said geographic location.

According to a second aspect of the present invention, there is provided a method comprising receiving information in a communications device for controlling a quality of service parameter for a service at a given time, said information being dependent on information about predicted load, as a function of time, in a geographical location associated with a current location of said communications device; and encoding with one of a plurality of bit rates in accordance with said information.

According to a third aspect of the present invention, there is provided an apparatus comprising means for using information about predicted load in a geographic location as a function of time to select a quality of service parameter at a particular time in said geographic location.

According to a fourth aspect of the present invention, there is provided an apparatus comprising means for receiving information in a communications device for controlling a quality of service parameter for a service at a given time, said information being dependent on information about predicted load, as a function of time, in a geographical location associated with a current location of said communications device; and means for encoding with one of a plurality of bit rates in accordance with said information.

According to a fifth aspect of the present invention, there is provided an apparatus comprising at least one processor; and at least one memory including computer programs, the at least one memory and the computer program code is configured to, with the at least one processor, cause the apparatus at least to perform encoding with one of a plurality of bit rates in accordance with received information, said information controlling a quality of service parameter for a service at a given time, said information being dependent on information about predicted load, as a function of time, in a geographical location associated with a current location of said apparatus.

According to a sixth aspect of the present invention, there is provided an apparatus comprising at least one processor; and at least one memory including computer programs, the at least one memory and the computer program code is configured to, with the at least one processor, cause the apparatus at least to use information about predicted load in a geographic location as a function of time to select a quality of service parameter at a particular time in said geographic location.

### BRIEF DESCRIPTION OF DRAWINGS

By way of example only, some embodiments of the present invention will now be described with reference to the accompanying drawings in which:

FIG. 1 shows an example of a communication system in which some example embodiments of the present invention may be implemented;

FIG. 2 shows an example of a communication device;

FIG. 3 show a processing arrangement for the selection of a codec mode;

FIG. 4 shows a communication system with PCC (Policy and Charging control) functions;

FIG. 5 shows a flow diagram for providing an algorithm for controlling guaranteed bit rate;

FIG. 6 shows a flow diagram for the selection of a codec or codec mode;

FIG. 7 shows a signal flow for bearer activation; and

FIG. 8 shows a network entity which determines a GBR.

### DETAILED DESCRIPTION OF EMBODIMENTS OF THE INVENTION

In the following description, various specific details are set forth in order to provide an understanding of some example embodiments of the invention. It is apparent, however, to one skilled in the art that the example embodiments of the invention may be practiced without the specific details or by an equivalent arrangement.

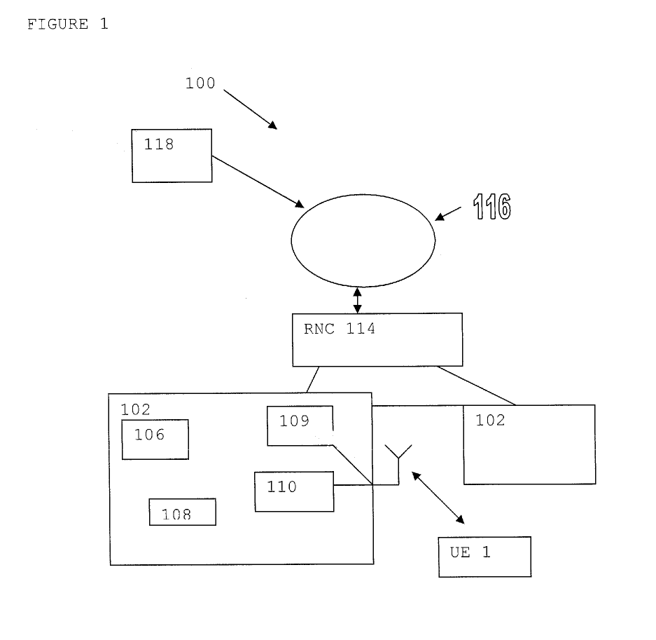

Reference is made to FIG. 1 which shows a telecommunications network 100. In some example embodiments of the present invention, the telecommunications network may be a long term evolution/system architecture evolution (LTE/SAE) as defined by 3GPP. However, it should be appreciated that this is by way of example only and other example embodiments of the present invention may be used with any other suitable wireless access technology or standard.

The telecommunications network comprises a plurality of network access entities 102. In this example, the network access entity is an evolved node B (eNB). However, the network access entity can be a node B (NB), a base station or any other suitable wireless network access entity.

The network access entity 102 will include at least one controller/processor 106, at least one memory 108, at least one transmitter 109 for sending data and at least one receiver 110 for receiving data. The transmitter 109 and receiver 110 may be connected to an antenna 101.

The network also comprises a number of user equipment 1.

The user equipment 1 is arranged to communicate with one or more network access entities 102 via a radio interface 11. It should be appreciated that one user equipment may be able to communicate with more than one network access entity at the same time.

The user equipment or any other suitable communication device can be used for accessing various services and/or applications provided via the communication network. In wireless or mobile communication systems, the access is provided via an access interface between the user equipment 1 and the network access entity 102.

The communication devices can access a communication network based on various techniques, such as code division multiple access (CDMA), or wideband CDMA (WCDMA), the latter technique being used by communication systems based on the 3GPP specifications. Other examples include time division multiple access (TDMA), frequency division multiple access (FDMA), space division multiple access (SDMA), hybrids of one or more of the above-mentioned access techniques and so on.

The user equipment may provide, for example a communication of data for carrying communications such as voice, electronic mail (e-mail), text messages, multimedia and so on. Thus, users of user equipment may thus be offered and provided with numerous services by their user equipment. Non-limiting examples of these services include two-way or multi-way calls, data communication or multimedia services, an access to a data communications network as the Internet or simply a voice call. The user may be provided by the user equipment with broadcast or multicast content. Non-limiting examples of the content include downloads, television and radio programmes, videos, advertisements, various alerts and other information. Some but not necessarily all of these services may have an associated guaranteed bit rate. This may mean that a desired quality of service may be provided.

It should be appreciated that the user equipment may be provided by any device capable of sending and receiving radio signals. Non-limiting examples include a mobile station (MS), a portable computer provided with a wireless interface card or other wireless interface facility, personal data assistant (PDA) provided with wireless communication abilities or any combinations of these or the like.

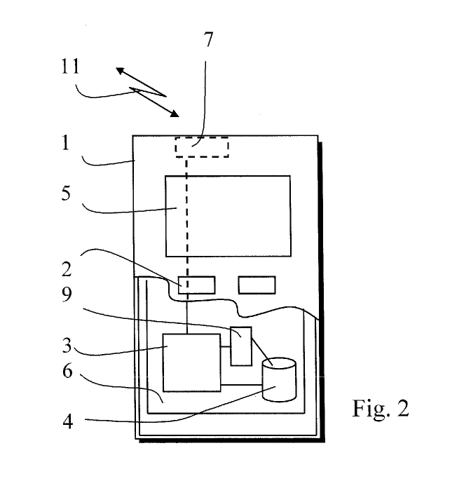

FIG. 2 shows a schematic, partly sectioned view of an example of a user equipment 1 usable in conformance with some example embodiments of the present invention.

The user equipment 1 may receive wireless signals via air interface 11 via appropriate apparatus/circuitry for receiving and may transmit signals via appropriate apparatus/circuitry for transmitting the radio signals. In FIG. 2, a transceiver (transmitter and receiver) is designated schematically by block 7. An associated antenna 12 may be connected to the transceiver block 7. The antenna may be arranged internally or externally to the user equipment.

The user equipment is also typically provided with at least one data processing entity 3. The data processing entity can be any suitable processor. The processor may be a single processor, dual core or a multi-core processor. The processing entity may be provided on a single integrated chip or provided by a plurality of integrated circuits (a so-called chip set).

The user equipment also comprises at least one memory 4 and may include other processor components 9. One or more of the data processing entity, the memory and other processor components may be used in software aided execution of tasks, for example control of access and communications with access systems and other communication devices.

The memory and other processor components may be provided on one or more integrated circuits or may be provided by any other suitable circuitry. Where at least part of these entities is provided on one or more integrated circuits, these may be the same or different integrated circuit(s), or circuits to that or those providing the data processing entity 3.

The data processing, storage and other relevant control apparatus can be provided on a circuit board, and/or in chip sets and/or provided by suitable circuitry. This feature is represented by reference 6.

The user may be able to control the operation of the user equipment by a suitable user interface and user interface circuitry. This may comprise, for example a keypad 2, voice commands, touch sensitive screen or pad, combinations thereof or the like. A display 5 and associated display software may be provided. Typically a speaker and microphone are also provided.

Referring back to FIG. 1, the network access entities 102 are shown as being connected to a radio network controller 114.

The radio network controller 114 is shown in FIG. 1 as being connected to two network access entities 102. In practice, the radio network controller 114 may be connected to more than two of these network access entities. In practice, a number of different radio network controllers may be provided. The functionality provided by the radio network controller may vary in dependence on the particular standard being implemented. For example, in the LTE/SAE system, a relatively flat radio access network structure is used. This means that the network access entities 102 make decisions in terms of resource allocation and the like. To this end, the network access entities 102 are provided with an interface there between (the so-called X2 interface).

The radio network controller 114 is connected to a core network 116. The core network comprises various different entities including an operation and management entity 118. The operation and management (O & M) entity 118 may be a single entity, a plurality of entities or implemented as a distributed function across several entities. The operation and management entity 118 collects the statistical behaviour of the load of the network at different geographical locations as a function of time. This data is collected from the network access entities. This will be discussed in more detail later.

The O & M entity may be responsible of the operation of the network and may allow the network operator to run the network in a managed way. O & M entities may monitor the performance and state of the network entities, collect statistics of the performance, any failure cases, errors, outage, otherwise degraded performance etc. Monitoring and logging the load of different network entities as a function of time is one task. In one example embodiment, the statistics of the load in for example a base station element is used to monitor the state of the network entities.

In the LTE/SAE system, the traffic is packet switched traffic, with no support for circuit switched traffic. The packet switched system uses guaranteed bit rate (GBR) allocation for certain services. Thus, a required quality of service for any application may be based on using a packet switched (PS) bearer with a suitable guaranteed bit rate allocation. Those applications which do not have any requirement for a guaranteed bit rate or any particular quality of service may use non-GBR bearers.

One example of a service which uses a GBR bearer is a voice or other audio service. A GBR bearer is used to ensure adequate quality of service and user experience. Another example of service which uses a GBR bearer is a video service. One example embodiment of the invention may be used with a service which can use different codecs. Another example embodiment of the invention may be used where there are different codec modes. A further example embodiment may be used where there are both different codecs and different codec modes.

In one example embodiment, the encoding/decoding used for voice over IP (VoIP) in LT/SAE may use a variable rate codec allowing different bit rate codec modes to be used.

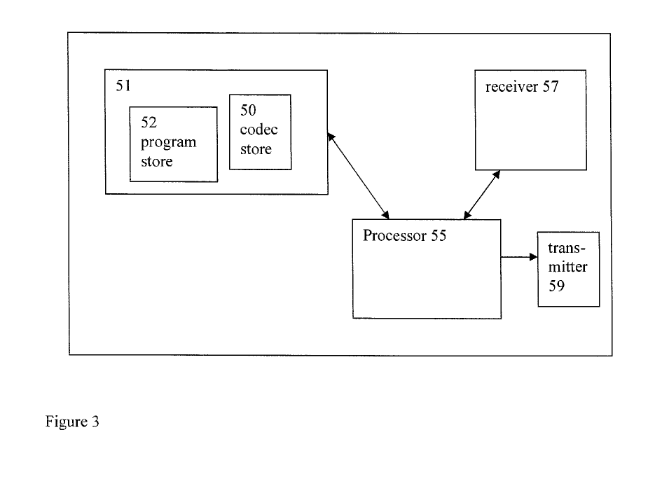

In this regard, reference is made to FIG. 3 which shows a processing arrangement for selection of a codec mode. This arrangement maybe provided in a network access entity and/or a user equipment.

The arrangement has a memory arrangement 51 (which may be a single memory or a plurality of memories) which comprises a codec store 50 and a computer program store 52. The codec store 50 stores one or more codecs. Each codec may have a plurality of modes. Each of these modes may have a different bitrate associated there with.

A receiver 57 may be provided which receives GBR information. The GBR information may be the GBR itself or information which allows the GBR to be determined or information which identifies the codec/codec mode to be identified. The receiver 57 may be arranged to provide the information to a processor 55. The processor 55 may use the information received to control which codec or codec mode is used. In particular the processor may be arranged to use the program code and codec or codec mode associated with the GBR information.

In one example embodiment there may be one codec with a plurality of modes. Alternatively, there may be a plurality of codecs with single modes. For a situation where there are a plurality of codec modes, the allocated GBR may determine the mode selected for use. For a situation where there are a plurality of codecs, the codec may be selected on the basis of the allocated GBR. A hybrid system may be use where there is at least one codec with a plurality of modes and at least one codec with a single mode.

The codec may be an AMR (adaptive multi-rate codec) and/or an AMR-WB (adaptive multi-rate-wideband codec). Other examples of codec are GSM Enhanced Full Rate (GSM-EFR) codec and GSM Half Rate (GSM-HR). In some example embodiments, the allocated GBR may result in selection between two or more fixed rate codecs like Enhanced Full Rate, Half Rate codec, etc. The computer program code store 52 stores the computer program code suitable for implementing the codec or codec mode.

By way of example only, Table 1 below sets out various options for the AMR codec mode and the associated number of bits:

TABLE 1
Source codec bit-rates for the AMR codec.

| Codec mode | Source codec bit-rate |
|---|---|
| AMR_12.20 | 12.20 kbit/s |
| AMR_10.20 | 10.20 kbit/s |
| AMR_7.95 | 7.95 kbit/s |
| AMR_7.40 | 7.40 kbit/s |
| AMR_6.70 | 6.70 kbit/s |
| AMR_5.90 | 5.90 kbit/s |
| AMR_5.15 | 5.15 kbit/s |
| AMR_4.75 | 4.75 kbit/s |
| AMR_SID | 1.80 kbit/s |

In some example embodiments of the present invention, it is possible to permit modification of the guaranteed bit rate parameter for a call or session to allow optimised utilisation of the system resources. This may mean more traffic is permitted.

In some example embodiments of the present invention, an operator of system may use the different codec rates of the AMR voice coding or any variable rate video/multimedia coding in order to maximise the system capacity.

It should be appreciated that there will be peaks in the load in the network and more specifically in the radio cell associated with a particular access node. Some example embodiments of the present invention are such that in high load situations, the GBR of the particular bearer can be reduced if it is determined that the service using the GBR bearer supports lower rates.

It should be appreciated that in one example embodiment of the present invention, a voice bearer may be allocated different GBRs dependent on the load in the system. This contrasts with previous systems where, for example a voice bearer is allocated a GBR corresponding to the voice bearer bit rate.

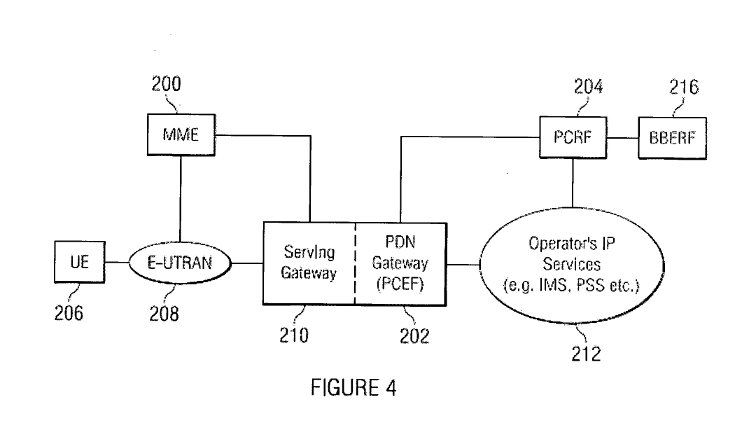

Reference is now made to FIG. 4 which shows some PCC (policy and charging control) functions.

The UE 206 may be connected to an E-UTRAN (Evolved Universal Mobile Telecommunications System Terrestrial Radio Access Network) 208. In some example embodiments, GBR is a QoS (quality of service) parameter of a EPS (evolved packed system) bearer. The EPS bearer may be 1-to-1 mapped to a radio bearer. The EPS bearer identity may be allocated by an MME (mobility management entity) 200. The E-UTRAN 208 may be connected to the MME 200. The MME 200 may be connected to a serving gateway 210 as may be the E-UTRAN 208.

The serving gateway 210 may be connected to the PDN (packet data network) GW (gateway) 202 which may provide a PCEF (policy and charging enforcement function). The PDNGW 202 may interact with a PCRF (policy and charging Rules function) 204 to get PCC (policy and charging control) rules or decisions for the one or more bearers. The PDN GW 202 may apply a local QoS policy. In one example embodiment, the PCRF may be used if dynamic PCC is used. Alternatively or additionally, if no dynamic PCC is deployed, then the PDN GW may be used.

The PCRF 204 may be connected to a BBERF (bearer binding and event reporting function) 216. The PCC function may be provided by the PCEF, the PCRF and the BBERF. Additional PCC functions may be provided by charging functions and subscriber profile databases.

The PDN GW 202 and the PCRF 204 may be connected to an Operator's IP (Internet Protocol services) which are indicated by reference 212.

In some example embodiments of the invention, an algorithm or formula for the traffic load statistics based GBR assignments may be part of the PCC function.

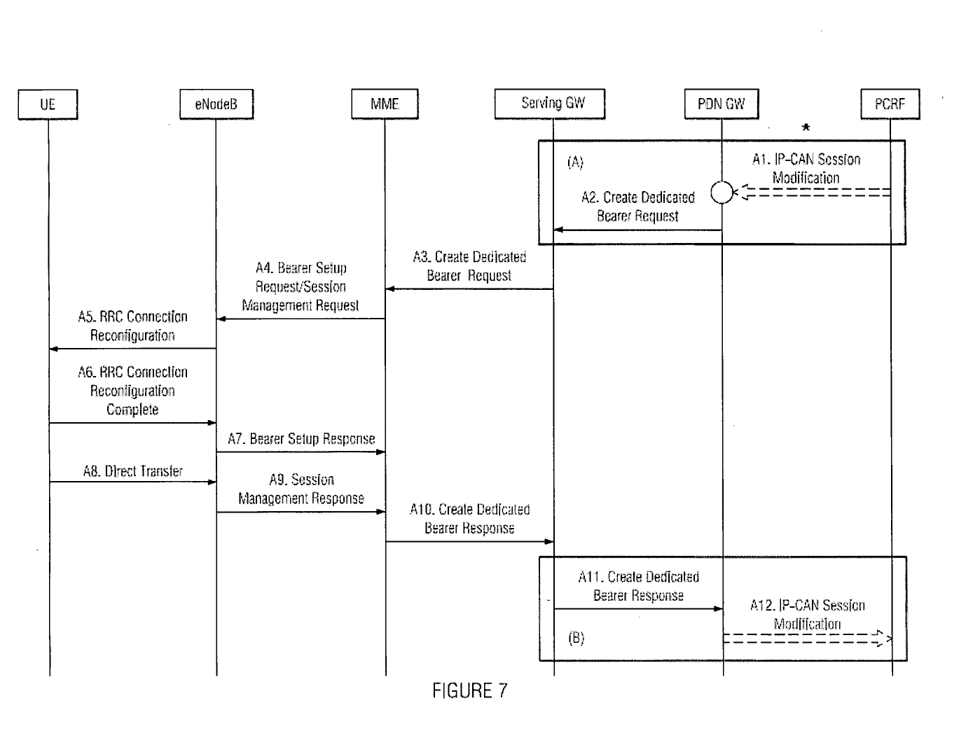

Reference is made to FIG. 7 which shows a signal flow.

In step A1, the PCRF may send an IP-CAN (IP connectivity access network) Session Modification message to the PDN GW. If dynamic PCC is deployed, the PRCF may send a PCC decision provision (QoS policy) to the PDN GW. This may correspond to an initial step of the PCRF-Initiated IP-CAN Session Modification procedure or to the PCRF response to the PCEF initiated IP-CAN session modification procedure, up to the point that the PDN GW requests IP-CAN bearer signalling (See step A12). If dynamic PCC is not used, then the PDN Gateway may apply the local QoS policy. The PCC decision may consist of PCC rules and IP-CAN bearer attributes which decision may be provided by the PCRF to the PCEF for policy and charging control.

In step A2, the PDN GW may select the GBR value assignment for the EPS bearer and send a Create Dedicated Bearer Request to the serving gateway. In particular, the PDN GW may use the QoS policy to assign the EPS Bearer QoS, that is the PDN GW assigns the values to the bearer level QoS parameters QCI (quality of service class indicator), ARP (allocation and retention priority), GBR and MBR (maximum bit rate). The Create Dedicated Bearer Request message has at least one of IMSI (international mobile subscriber identity), PTI (procedure transaction identifier), EPS bearer, QoS, TFT (traffic flow template), S5/S8, TEID (tunnel endpoint identifier), LBI (linked EPS bearer identity), and Protocol Configuration Options. The LBI is the identity of the default bearer. The PTI parameter may be used when the procedure was initiated by a UE requested bearer resource modification procedure. The Protocol Configuration Options may be used to transfer application level parameters between the UE and the PDN GW and are sent transparently through the MME and the serving GW. The network may signal the application the characteristics of the bearer. The network may set up the bearer. The signalling to the application and then setting up the bearer may be in this order or any other order. The application may adapt to those characteristics and select or reselect the codec or mode of the codec.

In step A3, a Create Dedicated Bearer Request may be sent from the serving gateway to the MME.

In step A4, a Bearer Setup Request/Session Management Request may be sent from the MME to the eNB.

In step A5, the eNB may send a RRC (radio resource control) Connection Reconfiguration message to the UE.

In step A6, the UE may reply with a RRC Connection Reconfiguration Complete message.

In step A7, the eNB may send a bearer setup Response to the MME.

In step A8, direct transfer from the UE to the eNB may take place.

In step A9, a Session Management Response may be sent from the eNB to the MME.

In step A10, a Create Dedicated Bearer Response may be sent from the MME to the serving gateway.

In step A11, the Create Dedicated Bearer Response may be sent from the serving GW to the PDN GW.

In step A12, the IP-Can Session Modification may be sent from the PDN GW to the PCRF. In this regard, reference is made to the discussion in relation to step A1.

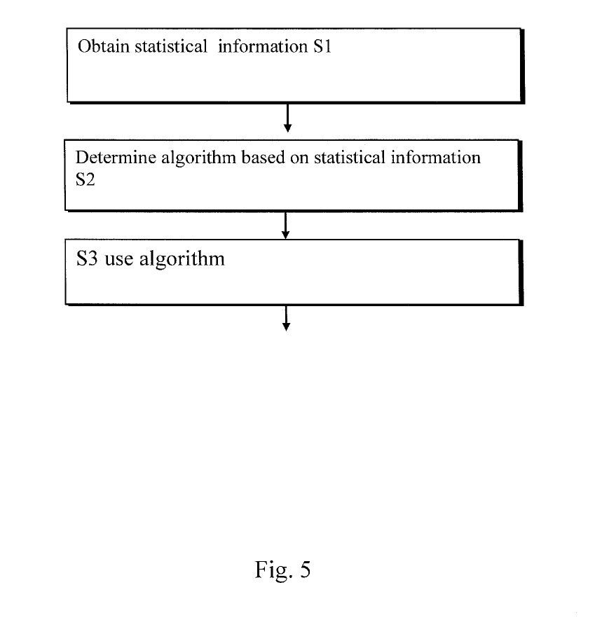

Reference is made to FIG. 5 which shows a flow diagram giving one example of the determining of a mapping such as an algorithm, a mapping function or the like for causing a particular GBR to be used. The steps shown in the flow diagram may be carried out in a single entity. That single entity may be, for example a network access entity, a quality of service controlling entity, a control entity such as, for example a radio network controller, the operation and management entity or a PCC entity for example as shown in FIG. 4. Alternatively, the steps can be carried out by two or more entities which may comprise one or more of the above mentioned entities.

In step S1, statistical information about the operation of a particular geographical area is obtained. This information may be collected by the O & M entity or other network management entity from for example a plurality of eNBs. In one example embodiment the statistical information collected is the statistical behaviour of load in the network as a function on time on different scales. The time scales may include one or more of the following: hourly variation in the course of day; variation over the week; and variation from month to month. In one example embodiment the statistical information is such that trends in usage and usage patterns are determined. For example, the times of day when the load increases can be identified. Those days when the load is likely to be higher can also be identified.

The geographical area can be any suitable area. For example, the geographic area can be a cell, or a group of cells or even a PLMN. In an alternative example embodiment of the present invention, the geographical information may be more precise geographical area, for example the geographical area may be the location of a school. In the alternative the geographical area may be a very much larger area which may be defined in terms of numbers of cells or a particular geographical location such as, for example a particular town or part of a town, or the site of an amenity such as a shopping centre, an airport, an office block, a station, or the like.

In one alternative example embodiment, it may not be necessary to collect statistical information for all areas. Statistical information can be collected from a subset of different areas which have different behaviour types. The statistical information which is collected for one particular geographical area having a given statistical behaviour may be considered to be representative for the same behaviour type.

The obtained statistical information may then be used in step S2 to determine an algorithm or mapping function or the like for policy and charging control. This algorithm may be limited to a particular geographical area.

The algorithm may be arranged so that when used, the algorithm may use the statistical determination to allocate the GBR for those services which require a GBR bearer using a variable codec or more than one codec with different bit rates, thus allowing the selection of the codec or the codec mode. The algorithm may make use of the statistical information to predict when an increased load is likely to occur in the geographical area and if necessary to decrease the GBR of the bearer.

In step S3, the algorithm may be used to allocate a GBR for a particular service at a particular time so that the user equipment and/or access node may use the corresponding codec mode to match the allocated GBR.

The algorithm for determining the GBR value from the statistical information may reside in the core network, in the same place where the QoS decision is made. As an alternative or additionally, mapping logic may be provided to map the location, time and corresponding GBR for a given type of call. In one example embodiment a mapping function may be provided.

The allocated GBR for a particular service at a particular time and location can be propagated in any suitable manner. The specific algorithm may be sent, if necessary, to the network node allocating the GBR.

In one example embodiment, the allocation of the guaranteed bit rate for a variable rate multimedia service may depend on the statistical information which has been collected. The entity creating a rule for the GBR allocation may take into account the time and the rule, corresponding to the knowledge which has been obtained from the statistical information. This example embodiment may preclude the need for any additional system complexity.

In one example embodiment of the present invention, a lower GBR resulting in a lower quality in voice or video or any other media may be used only when the statistics show a significant expected peak in the network load.

In one example, during the expected rush hour in an area, the GBR for a voice call may be set to a first rate whilst in the normal hours of the day, the GBR may be set to a second rate. By way of example only, the first rate may be 6 kbit/s whilst the second bitrate may be 12.2 kbit/s.

Consider another example where the rule for GBR allocation is set for a geographic area which covers a school area. Rather than collecting statistics, this is based on expected user behaviour taking into account, for example, usual working hours, usual working days, seasonal variations due to holidays or the like. Accordingly, a time of increased load in the network may be just before the school starts, just after school has broken up and during break time. The GBR can then be lowered at these times of increased load. Additionally, times when the school is on holiday can also be taken into consideration such that the lowering of the GBR allocation would not take place at this time.

In alternative example embodiments, a different method may be used for predicting times at which the load conditions are at a peak. Again this takes into account expected user behaviour. For example, at a train station, the prediction of peak loading may be based on external parameters such as the number of trains arriving and departing at a particular time. In another example embodiment, the GBR allocation for the cells covering a particular highway may take into account expected load during the morning rush hour and late afternoon rush hour.

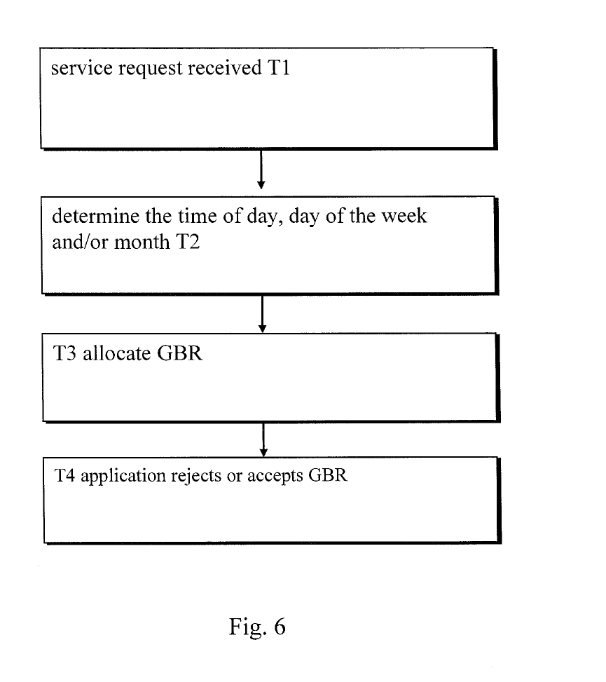

Reference is now made to FIG. 6 which shows how the mapping may be applied. The QoS control for calls may take place in the Core Network (CN) of the system. There in the CN the mapping may be done between the Application (e.g., VoIP application with the codecs) and the “bearer plane”. That is, the CN may create the bearers (offers the bearer service) for the application. Examples of the entities where the QoS decision may be made, regarding the GBR for the call are a PCC entity such as the PCRF, or a PDN GW or GGSN (Gateway GPRS(general packet radio service support node). The latter node may be used in 3G and/or 2G networks). Other examples of entities are described previously. The application may request the bearer, the entity in question may check what bearers can be offered, allocates a bearer and the application may either reject or accept. With a selection of codecs and/or codec modes with different bit rates, the application may be able to adapt to the characteristics of the bearer. The entity in question may have access to the load statistics and can use them in determining the optimal GBR for the call.

In one example embodiment, the network may allocate the GBR for the bearer and the application may then adapt to that GBR. The network may not allocate the codec or codec mode directly in some example embodiments, but the codec may instead be negotiated on the application layer between the call end points. In alternative example embodiments, the codec or codec mode may be allocated directly by the network.

In step T1 of FIG. 6, a bearer request may be received. An application may signal a service request with characteristics to the network. In step T1, the reception of the service request in the QoS controlling entity (for example, one or more of the PCC, PCRF and PDN GW) may trigger the GBR allocation logic.

In step T2, the time may be determined in terms of hour, day of the week and/or month.

In step T3, the determined time and algorithm/mapping logic may be used to determine whether the predicted load is such that the GBR needs to be altered for a particular service. The network entity may assign the GBR and the rest of the parameters for the bearer.

In step T4, the application may then accept or reject the allocated GBR.

In some example embodiments the network may analyse the request and establish a bearer for the application. The bearer may now have the GBR parameter assigned. This may result in the application selecting the codec mode or codec accordingly, as a consequence of the GBR allocation.

Codecs may be application specific. One example of an application is a VoIP call client. The application may use the bearer services offered by the network. The codec may be selected by the application.

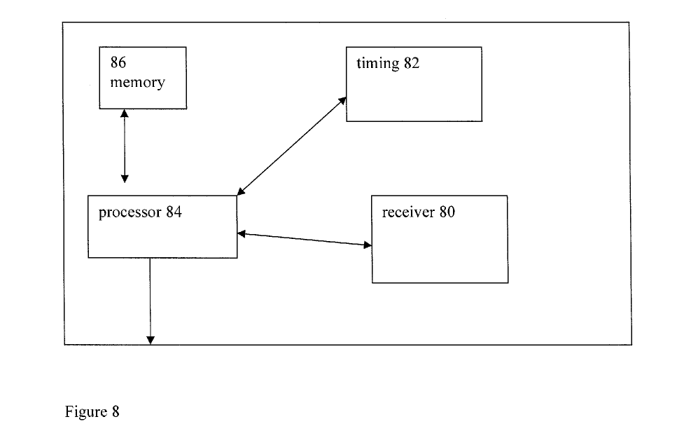

FIG. 8 schematically shows part of a network entity which may make a GBR decision. The network entity may have one or more memories 86 which are arranged to store mapping logic and a timing block 82 which may provide timing information. A receiver 80 is provided which may receive network requests. One or more processors 84 may be provided. The one or more processors 84 may be triggered, in response to receiving a request, to obtain current time information and mapping logic and to thereby allocate a GBR.

An example of the invention is: a method comprising using information about predicted load in a geographic location as a function of time to select a quality of service parameter at a particular time in said geographic location.

Another example of the invention is: a method comprising receiving information in a communications device for controlling a quality of service parameter for a service at a given time, said information being dependent on information about predicted load, as a function of time, in a geographical location associated with a current location of said communications device; and encoding with one of a plurality of bit rates in accordance with said information.

A further example of the invention is: an apparatus comprising means for using information about predicted load in a geographic location as a function of time to select a quality of service parameter at a particular time in said geographic location.

A further example of the invention is: an apparatus comprising means for receiving information in a communications device for controlling a quality of service parameter for a service at a given time, said information being dependent on information about predicted load, as a function of time, in a geographical location associated with a current location of said communications device; and means for encoding with one of a plurality of bit rates in accordance with said information.

A further example of the invention is: an apparatus comprising at least one processor; and at least one memory including computer programs, the at least one memory and the computer program code is configured to, with the at least one processor, cause the apparatus at least to perform encoding with one of a plurality of bit rates in accordance with received information, said information controlling a quality of service parameter for a service at a given time, said information being dependent on information about predicted load, as a function of time, in a geographical location associated with a current location of said apparatus.

A further example of the invention is: an apparatus comprising at least one processor; and at least one memory including computer programs, the at least one memory and the computer program code is configured to, with the at least one processor, cause the apparatus at least to use information about predicted load in a geographic location as a function of time to select a quality of service parameter at a particular time in said geographic location.

As used in this application, the term “circuitry” refers to all of the following:

a) hardware-only circuit implementations (such as implementations in only analog and/or digital circuitry) and
b) to combinations of circuits and software (and/or firmware), such as (as applicable): i) to a combination of processor(s) or ii) to portions of processor(s)/software (including digital signal processor(s)), software, and memory(ies) that work together to cause an apparatus, such as a mobile phone or server, to perform various functions) and
c) to circuits, such as microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

1.-68. (canceled)

69. A method comprising:
obtaining, at a network entity, predicted load information for a geographic location; and
using said predicted load information to select a quality of service parameter for a particular time in said geographic location.

70. The method of claim 69, wherein said predicted load information is obtained from collected statistical load information.

71. The method of claim 70, wherein said statistical load information is collected for said geographic location over a period of time.

72. The method of claim 69, wherein said predicted load information is dependent on predicted behavior of users of a service over time for said geographic location.

73. The method of claim 69, wherein said quality of service parameter comprises guaranteed bit rate.

74. The method of claim 69, wherein said geographic location comprises one of: a cell, a group of cells, part of a network, a network, a town, part of a town, and a site of an amenity.

75. The method of claim 69, further comprising: receiving quality of service policy information, said quality of service policy information being used to select said quality of service parameter.

76. Apparatus comprising:
at least one processor and
at least one memory including computer program code,
the at least one memory and the computer program code configured to, with the at least one processor, cause the apparatus at least to:
obtain predicted load information for a geographic location; and
use said predicted load information to select a quality of service parameter for a particular time in said geographic location.

77. The apparatus of claim 76, wherein said predicted load information is obtained from collected statistical load information.

78. The apparatus of claim 77, wherein said statistical load information is collected for said geographic location over a period of time.

79. The apparatus of claim 77, wherein said predicted load information is dependent on predicted behavior of users of a service over time for said geographic location.

80. The apparatus of claim 77, wherein said quality of service parameter comprises guaranteed bit rate.

81. The apparatus of claim 77, wherein said geographic location comprises one of: a cell, a group of cells, part of a network, a network, a town, part of a town, and a site of an amenity.

82. The apparatus of claim 77, further comprising a receiver configured to receive quality of service policy information, and the at least one memory further comprising computer program code configured to, with the at least one processor, cause the apparatus at least to use said quality of service policy information to select said quality of service parameter.

83. A computer program product comprising at least one computer-readable medium having computer-readable program instructions stored therein, the computer-readable program instructions comprising instructions, which when performed by a processor, are configured to cause an apparatus to at least perform:
obtaining predicted load information for a geographic location; and
using said predicted load information to select a quality of service parameter for a particular time in said geographic location.

84. The computer program product of claim 83, wherein said predicted load information is determined from collected statistical load information.

85. The computer program product of claim 84, wherein said predicted load information is dependent on predicted behavior of users of a service over time for said geographic location.

86. The computer program product of claim 83, wherein said quality of service parameter comprises guaranteed bit rate.

87. The computer program product of claim 83, wherein said geographic location comprises one of: a cell, a group of cells, part of a network, a network, a town, part of a town, and a site of an amenity.

88. The computer program product of claim 83, the computer-readable program instructions further comprising instructions, which when performed by a processor, are configured to cause an apparatus to at least further perform:
receiving quality of service policy information; and
using said quality of service policy information to select said quality of service parameter.
